(19) United States
(12) Patent Application Publication
(10) Pub. No.: US 2010/0059911 A1
(43) Pub. Date: Mar. 11, 2010

(54) ADJUSTABLE GAS DAMPING VIBRATION AND SHOCK ISOLATION SYSTEM

(75) Inventors: Scott J. Goepfert, White Bear Lake, MN (US); Todd L. Braman, New Bringhton, MN (US); Matthew Schlager, Maplewood, MN (US); Jacob Weinmann, Roseville, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/205,349

(22) Filed: Sep. 5, 2008

(51) Int. Cl. F16F 9/00

(52) U.S. Cl. 267/140.11

(57) ABSTRACT

An inertial measurement unit includes a housing with openings to permit fluid communication between at least one pressure source and two distinct cavities within the housing. The cavities are separated by an inertial sensor assembly coupled to a vibration isolator assembly. The pressure in the cavities may be adjusted or tuned to change a natural frequency of the inertial measurement unit, thus allowing the unit to be configured and even optimized for a variety of different applications. By adjusting the pressure in the respective cavities, gas squeeze film damping effects may be optimized when the inertial measurement unit undergoes a shock event and/or when the inertial measurement unit experiences vibration loads during operation. In one embodiment, the vibration isolator assembly includes perforations to permit fluid communication between the first and second cavities during specific operational events.

### BACKGROUND OF THE INVENTION

Inertial measurement units (IMUs) are used in a variety of applications. An IMU is the main component of inertial guidance systems used in air and space vehicles, watercraft vehicles and guided missiles. IMUs work by detecting the current rate of acceleration, as well as changes in rotational attributes, including pitch, roll and yaw using a combination of accelerometers and gyroscopes. The data collected from these sensors allows a computer to track a vehicle's position using a method known as dead reckoning. The term IMU commonly refers to a box containing three accelerometers and three gyroscopes. The accelerometers are placed such that their measuring axes are orthogonal to each other so they can measure inertial acceleration, also known as G-forces.

The performance of an IMU is dependent on the vibration a shock isolation of its inertial sensor(s) within the units. Further, depending on the application, the vibration and shock environments to which the IMUs are subjected may be drastically different, this makes it difficult to design and manufacture a common IMU that will satisfy multiple applications.

Honeywell, one of the leading producers of IMUs, makes IMUs that serve the unique and demanding requirements of precision guided tactical and strategic guidance and navigation platforms of all types including: missiles, guided projectiles, ballistic interceptors, unmanned vehicles, targets, and torpedoes. By way of example, Honeywell is also pioneering super-miniaturized inertial navigation systems using Micro ElectroMechanical Systems (MEMS) technology that enables revolutionary gun-hard performance. In such applications, the IMUs should be both small and robust. These systems may be referred to as gun hard applications and often must meet shock requirements having a 20,000 G-force set back.

### SUMMARY OF THE INVENTION

The present invention general relates to an inertial measurement unit having a housing with openings to permit fluid communication between at least one pressure source and two distinct cavities within the housing. The cavities are separated by an inertial sensor assembly coupled to a vibration isolator assembly. The pressure in the cavities may be adjusted or tuned to change a natural frequency of the inertial measurement unit, thus allowing the unit to be configured and even optimized for a variety of different applications. By adjusting the pressure in the respective cavities, gas squeeze film damping effects may be optimized when the inertial measurement unit undergoes a shock event and/or when the inertial measurement unit experiences vibration loads during operation. In one embodiment, the vibration isolator assembly includes perforations to permit fluid communication between the first and second cavities during specific operational events.

In one aspect of the invention, an inertial measurement unit includes a housing having a housing wall defining an internal cavity; an inertial sensor assembly located within the cavity; a vibration isolator assembly arranged within the cavity and coupled to the inertial sensor assembly and the housing wall to suspend the inertial sensor assembly within the cavity, wherein the vibration isolator assembly and the inertial sensor assembly are arranged to separate the cavity into a first cavity and a second cavity; a first opening positioned in the housing wall to permit fluid communication between the first cavity and a first pressure source; and a second opening positioned in the housing wall to permit fluid communication between the second cavity and a second pressure source, wherein pressures in the first and second cavities are adjustable to obtain a desired squeeze film damping for the inertial sensor assembly.

In another aspect of the invention, an inertial measurement unit includes a housing having housing walls; an inertial sensor assembly elastomerically supported with a vibration isolator assembly between a first housing wall and a second housing wall such that a first cavity is sealingly separated from a second cavity within the housing; a first opening positioned in at least one of the housing walls to permit fluid in the first cavity to be pressurized to a first desired pressure; and a second opening positioned in at least one of the housing walls to permit fluid in the second cavity to be pressurized to a second desired pressure.

In yet another aspect of the invention, a method for regulating squeeze film damping effects within an inertial measurement unit includes the steps of (1) adjusting a first pressure within a first cavity in a housing for the inertial measurement unit; and (2) adjusting a second pressure within a second cavity in the housing for the inertial measurement unit, the second cavity sealingly separated from the first cavity by an arrangement of an inertial sensor assembly coupled to a vibration isolator assembly.

### BRIEF DESCRIPTION OF THE DRAWINGS

Preferred and alternative embodiments of the present invention are described in detail below with reference to the following drawings:

FIG. 1 is cross-sectional schematic view of an inertial measurement unit having two cavities separated by an inertial sensor assembly coupled to a vibration isolator assembly according to an embodiment of the invention; and

FIG. 2 is a flow diagram showing a method for adjusting separate cavity pressures within an inertial measurement unit according to an embodiment of the invention.

### DETAILED DESCRIPTION OF ONE EMBODIMENT

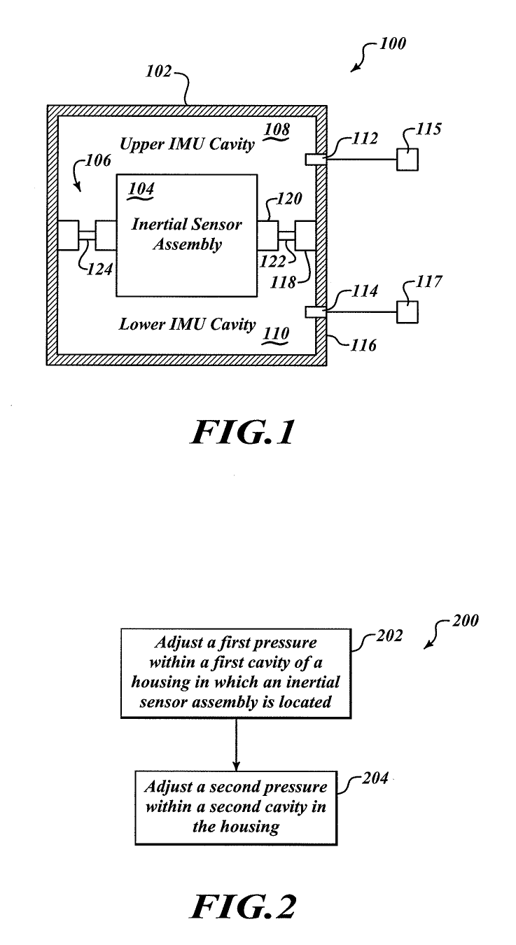

FIG. 1 schematically shows an inertial measurement unit (IMU) 100 having a housing 102. Located within the housing 102, an inertial sensor assembly 104 (otherwise referred to as an inertial cluster) is coupled to a vibration isolator assembly 106. The arrangement of the IMU 104 coupled to the vibration isolator assembly 106 creates a first cavity 108 (e.g., upper cavity as illustrated) and a second cavity 110 (e.g., lower cavity as illustrated) within the housing 102.

The housing 102 includes openings 112, 114 that extend through the housing wall 116. The openings 112, 114 permit fluid, generally a gas such as air or Nitrogen, to be exchanged between the respective cavities 108, 110 and at least one external pressure source (not shown). One purpose of the openings 112, 114 is to adjust the pressure in each cavity and thereby tune the IMU 100 to have a desired natural frequency. Another purpose of the cavities 108, 110 and the openings 112, 114 is to control or even optimize the squeeze film damping effects for a specific end-user application. Squeeze film damping is generally understood to be a gaseous compressible fluid, such as air, used as a damping media between two parallel plates, with one stationary plate and one suspended plate that is allowed to move in a transverse motion, resulting in motion between the plates at a desired frequency. This modality is referred to as gas squeeze film damping. By way of example, the openings 112, 114 may be sized to receive valves (not shown) to better control the exchange of fluid between the cavities 108, 110 and the respective pressure sources 115, 117. Although two independent pressure sources 115, 117 are shown in the illustrated embodiment, it is appreciated that a single pressure source may be utilized to adjust the pressure in both of the cavities 108, 110.

The housing 102 and the inertial sensor assembly 104 may be commercially available devices or may be customized for specific applications. In one embodiment, the vibration isolator assembly includes a metal support member 118 coupled to the housing 102, a metal support member 120 coupled to the inertial sensor assembly 104 and an elastomeric member 122 extending between the respective metal support members 118, 120. In one embodiment, the metal support members 118, 120 and the elastomeric member 122 take the form of a ring and also form a seal between the cavities 108, 110. In another embodiment, the elastomeric member 122 includes perforations or openings 124 sized to allow an amount of fluid exchange between the cavities 108, 110 during certain operational events, such as during a shock event, commonly referred to as a setback shock event that occurs during a gun or missile launch.

FIG. 2 shows a flow diagram showing a method 200 for regulating squeeze film damping effects within an inertial measurement unit. At 202, the method provides for adjusting a first pressure within a first cavity in a housing for the inertial measurement unit 100, which was described above. At 204, the method 200 provides for adjusting a second pressure within a second cavity in the housing. The second cavity may be sealingly separated from the first cavity by an arrangement of an inertial sensor assembly coupled to a vibration isolator assembly. In an alternate embodiment, the method 200 may include exchanging a fluid within the first cavity with a fluid within the second cavity through a plurality of perforations located in the vibration isolator assembly during a shock event.

While one embodiment of the invention has been illustrated and described, as noted above, many changes can be made without departing from the spirit and scope of the invention. Accordingly, the scope of the invention is not limited by the disclosure of one embodiment. Instead, the invention should be determined entirely by reference to the claims that follow.

The embodiments of the invention in which an exclusive property or privilege is claimed are defined as follows:

1. An inertial measurement unit comprising:
a housing having a housing wall defining an internal cavity;
an inertial sensor assembly located within the cavity;
a vibration isolator assembly arranged within the cavity and coupled to the inertial sensor assembly and the housing wall to suspend the inertial sensor assembly within the cavity, wherein the vibration isolator assembly and the inertial sensor assembly are arranged to separate the cavity into a first cavity and a second cavity;
a first opening positioned in the housing wall to permit fluid communication between the first cavity and a first pressure source; and
a second opening positioned in the housing wall to permit fluid communication between the second cavity and a second pressure source, wherein pressures in the first and second cavities are adjustable to obtain a desired squeeze film damping for the inertial sensor assembly.

2. The inertial measurement unit of claim 1, wherein each opening is sized to receive a valve.

3. The inertial measurement unit of claim 1, wherein the vibration isolator assembly includes a first support coupled to the housing wall, a second support coupled to the inertial sensor assembly and an elastomeric member extending between the first and second supports.

4. The inertial measurement unit of claim 1, wherein the vibration isolator assembly operates with the inertial measurement unit to sealingly separate the first and second cavities within the housing.

5. The inertial measurement unit of claim 1, wherein the vibration isolator assembly includes a plurality of perforations that permit fluid communication between the first and second cavities.

6. The inertial measurement unit of claim 1, wherein the vibration isolator assembly includes a plurality of perforations that permit fluid communication between the first and second cavities only during a shock event.

7. The inertial measurement unit of claim 1, wherein the pressure in the first cavity is substantially the same as the pressure in the second cavity.

8. The inertial measurement unit of claim 1, wherein the first pressure source is the same as the second pressure source.

9. An inertial measurement unit comprising:
a housing having housing walls;
an inertial sensor assembly elastomerically supported with a vibration isolator assembly between a first housing wall and a second housing wall such that a first cavity is sealingly separated from a second cavity within the housing;
a first opening positioned in at least one of the housing walls to permit fluid in the first cavity to be pressurized to a first desired pressure; and
a second opening positioned in at least one of the housing walls to permit fluid in the second cavity to be pressurized to a second desired pressure.

10. The inertial measurement unit of claim 9, further comprising:
a first valve located in the first opening to control the first desired pressure in the first cavity.

11. The inertial measurement unit of claim 9, further comprising:
a second valve located in the second opening to control the second desired pressure in the second cavity.

12. The inertial measurement unit of claim 9, wherein the vibration isolator assembly includes metal support members coupled to an elastomeric member.

13. The inertial measurement unit of claim 9, wherein the vibration isolator assembly includes a plurality of perforations that permit fluid communication between the first and second cavities.

14. The inertial measurement unit of claim 9, wherein the vibration isolator assembly includes a plurality of perforations that permit fluid communication between the first and second cavities only during a shock event.

15. The inertial measurement unit of claim 9, wherein the first desired pressure is substantially the same as the second desired pressure.

16. A method for regulating squeeze film damping effects within an inertial measurement unit, the method comprising:
adjusting a first pressure within a first cavity in a housing for the inertial measurement unit; and
adjusting a second pressure within a second cavity in the housing for the inertial measurement unit, the second cavity sealingly separated from the first cavity by an arrangement of an inertial sensor assembly coupled to a vibration isolator assembly.

17. The method of claim 16, further comprising:
exchanging a fluid within the first cavity with a fluid within the second cavity through a plurality of perforations located in the vibration isolator assembly during a shock event.

18. The method of claim 16, wherein adjusting the first and second pressures includes changing a natural frequency of the inertial measurement unit.

19. The method of claim 16, wherein adjusting the first pressure within the first cavity includes exchanging a fluid between a pressure source and the first cavity.

20. The method of claim 16, wherein adjusting the second pressure within the second cavity includes exchanging a fluid between a pressure source and the second cavity.
